(19) United States
(12) Patent Application Publication
(10) Pub. No.: US 2008/0235401 A1
(43) Pub. Date: Sep. 25, 2008

(54) Method of storing media data delivered through a network

(76) Inventors: Tak Wing Lam, Shatin (HK); Ka Yuk Lee, Shatin (HK); Chun Yin Ng, Shatin (HK)

Correspondence Address: JACOBSON HOLMAN PLLC, 400 SEVENTH STREET N.W., SUITE 600, WASHINGTON, DC, 20004, US

(21) Appl. No.: 11/723,747

(22) Filed: Mar. 21, 2007

(51) Int. Cl. G06F 15/16

(52) U.S. Cl. 709/246

(57) ABSTRACT

There are various methods to stream media data, particularly video data, through a network for playing on a client workstation, for example, WMV™, Real™ Video, and so on. If multiple formats are involved, it is difficult to store the media data, and streaming the stored data whenever required. Further, existing devices are not able to record digital AV content from IP network, DVB, or AV encoder. The current invention provides a method of storing media data delivered to a client, for example via the internet. The media data can be encoded more than one format. The format of the media data is first identified when the media data is received by the client, and then analyzed to extract unit attributes from the media data. The unit attributes are stored in a media attribute file. The media data is then stored to a media storage file according to the sequence of the media data sent to the client. The media data stored by the methods of this invention can then be played by a player software.

### FIELD OF THE INVENTION

This invention relates to methods of storing media data delivered through network, particularly video data, and methods of playing the stored media data.

### BACKGROUND OF THE INVENTION

There are various methods to stream media data, particularly video data, through a network for playing on a client workstation, for example, WMV™, Real™ Video, and so on. If multiple formats are involved, it is difficult to store the media data, and streaming the stored data whenever required.

Recorders using DVD and/or hard disk as the storage medium have been available in the market, and is replacing traditional video recorders in the consumer market. In the meantime, the digital AV transmission have also been implemented in countries like US and Japan. Various applications like DVB-T broadcast, video on demand (VOD) and IPTV are now available using digital AV transmission technology. However, existing devices are not able to record digital AV content from IP network, DVB, or AV encoder, and then broadcast such the recorded signals.

### OBJECTS OF THE INVENTION

Therefore, it is an object of this invention to provide a method of encoding digital AV content so that such can be recorded. It is yet an object of this invention to resolve at least one or more of the problems as set forth in the prior art. As a minimum, it is an object of this invention to provide the public with a useful choice.

### SUMMARY OF THE INVENTION

Accordingly, this invention provides a method of storing media data delivered to a client, said media data being encoded in at least one format, said method including the steps of:
identifying the format of the media data whenever the media data is received by the client;
analyzing the media data to extract unit attributes from the media data, wherein said unit attributes includes timestamp, size, media type, stream type, and random access point flag; and wherein said unit attributes are stored in a media attribute file;
storing the media data to a media storage file according to the sequence of the media data sent to the client.

Preferably, the method of this invention further includes the step of:
analyzing the media data to extract random access attributes from the media data, said random attributes
   including timestamp, unit identifier, and unit offset; and
   being stored in a random access attribute file.

The method of this invention may further include the step of:
repeating the steps of claim 1 whenever the format of the media data is changed.

Preferably, the media data could be video or audio data.

Optionally, the media data delivered to the client via internet.

It is another aspect of this invention to provide a system of storing media data delivered to a client, said media data being encoded in at least one format, said system including:
a processor for identifying the format of the media data whenever the media data is received by the client;
a first analyzer for analyzing the media data to extract unit attributes from the media data, wherein said unit attributes includes timestamp, size, media type, stream type, and random access point flag; and wherein said unit attributes are stored in a media attribute file;
storage medium for storing the media data to a media storage file according to the sequence of the media data sent to the client.

Preferably, the system this invention further includes a second analyzer for analyzing the media data to extract random access attributes from the media data, said random attributes
including timestamp, unit identifier, and unit offset; and
being stored in a random access attribute file.

### BRIEF DESCRIPTION OF THE DRAWINGS

Preferred embodiments of the present invention will now be explained by way of example and with reference to the accompanying drawings in which:

FIG. 1 shows the overall scheme of the handling of different audio/visual signal streams by the encoding method of this invention;

FIG. 2 shows the logical structure of the Source Info, Media Stream Info, Unit Attribute, and Rap Attribute files of this invention; and

FIG. 3 shows a flow chart describing the operation of the Universal Stream Recording Engine of this invention.

### DETAILED DESCRIPTION OF THE PREFERRED EMBODIMENTS

This invention is now described by way of example with reference to the figures in the following paragraphs.

Objects, features, and aspects of the present invention are disclosed in or are obvious from the following description. It is to be understood by one of ordinary skilled in the art that the present discussion is a description of exemplary embodiments only, and is not intended as limiting the broader aspects of the present invention, which broader aspects are embodied in the exemplary constructions.

Even though some of them may be readily understandable to one skilled in the art, the following Table 1 shows the abbreviations or symbols used through the specification together with their meanings so that the abbreviations or symbols may be easily referred to.

| Abbreviation/Symbol | Meaning |
|---|---|
| CODEC | The encoder, decoder pair for a Media Stream. Each codec will |
| | correspond to a Media Type. |
| ES | A Stream Type indicating that the Media Stream is an elementary |
| | stream. |
| TS | A Stream Type indicating that the Media Stream is a TS stream |
| | (defined in ISO standard ISO13818-1). |
| RTP | A Stream Type indicating that the Media Stream is an RTP stream |
| | (defined in IETF's RFC3550). |
| Stream Type | An identification of the transport protocol used for the Source |
| | Stream. |
| Source Stream | A collection of one or more Media Streams. |
| Media Type | An identification of the CODEC used for the Media Stream. |
| Media Sample | A packet (defined by the Stream Type) received by the recording |
| | engine. |
| | For Stream Type ES, it is the smallest unit, defined by the CODEC |
| | specified in Media Type. A timestamp can be attached to the |
| | Media Sample in such a case. |
| | For Stream Type TS, it is a TS packet. |
| | For Stream Type RTP, it is an RTP packet. |
| Media Stream | A stream of one or more Media Samples. |
| Timestamp | Value used to infer the time at which the (decoded) sample should |
| | be rendered (presented to the audience). |
| Sample Sequence | An ordering scheme of the Media Samples given by the |
| | sender/creator according to the Stream Type. |
| Sample Number | A number that can be used to infer a Media Sample's order in |
| | Media Stream. |
| Size | Size needed to store the Media Sample. |
| RapFlag | RAP stands for Random Access Point. A Media Sample with |
| | RapFlag can be decoded without referencing any other Media |
| | Sample. Whether a Media Sample has RAP depends on its content |
| | and the Stream Type/Media Type. |
| | This attribute is useful when performing seek, fast fordward and/or |
| | fast backward operations. |

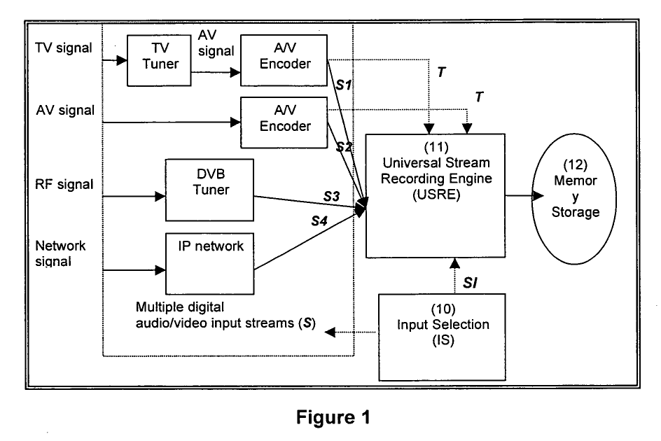

A general scheme of the encoding method of this invention, which may be named as Universal Stream Recording Engine USRE (11) is shown in FIG. 1. As shown, USRE is able to handle multiple audio/video streams. An input selector IS (10) is used to select one of the source stream S among the available source streams, say S1 to S4 and let USRE (11) knows which S will feed data to the USRE (11). The IS (10) is also responsible for triggering start and stop the process of the USRE (11), and setup S by sending the corresponding Source Info SI to the USRE (11). The source streams S1 to S4 will be source streams with contents defined by the SI, which would be sent through the network according to the particular application environment. For example, S1 may contain one video and one audio ES, while S4 maybe a TS stream, as indicated by the respective SI1 and SI4.

The following are a few examples of how the S can be set up according to various scenarios:
If SI contains two Media Streams, one with Stream Type ES, Media Type (for example MP4V) and one with Stream Type ES, Media Type (for example AAC). Then S will contain one elementary stream of MPEG 4 video and one elementary stream of AAC audio.
For a TV/AV signal source, the USRE (11) can be setup to utilize a predefined encoding media format, e.g. video—MP2V, MP4V, H.264, and so on and/or audio format—MP2A, AAC, and so on.
   In this particular case, SI would contain two Media Streams, one with Stream Type ES, Media Type set to be the predefined video codec, and one with Stream Type ES, Media Type set to be the predefined audio codec.
   For the video ES, Media Sample can be an encoded video picture (or frame). For the audio ES, Media Sample can be an audio frame (defined by the predetermined audio codec used).
   For each Media Sample with type Stream Type ES, a corresponding Timestamp t can be got from the AV encoder.
For an RF signal source (S3), the Digital Video Broadcasting (DVB) tuner, which could receive RF signal and demodulates such signals to TS stream, is used to tune to appropriate TV channel such that it can output correspondence stream data to the USRE (11). In this case, the SI would contain one Media Stream with Stream Type TS, and the Media Type can be ignored or set to a null value.
For a network source (S4), the USRE (11) can be setup to receive the appropriate networking stack (e.g. RTP, TS). In this case, the SI can contain one Media Stream with Stream Type TS, and the Media Type can be ignored or set to a null value.

When an audio or video data stream is received by the USRE (11), the Source Stream S and timing information would be captured by the USRE (11) if the Media Stream's Stream Type is ES. The USRE (11) would then store the Media Streams in memory in additional with Unit Attributes (and optional Rap Attribute). After that, a software application can access this memory and perform playback, streaming or time shift feature. The detail process will be discussed on the following session.

### Details of the USRE (11)

The operation of the USRE (11) may be triggered by an Input Selector (IS) under two conditions:
(i) S has been changed e.g. change of S from DVB S3 to AV S2,
(ii) S has been stopped.

USRE could also be triggered by user intervention (for example, request for timeshift, trickplay and recording functions), or to provide certain feature (start/stop when a scheduled recording commences/expires), which are described in the later sections.

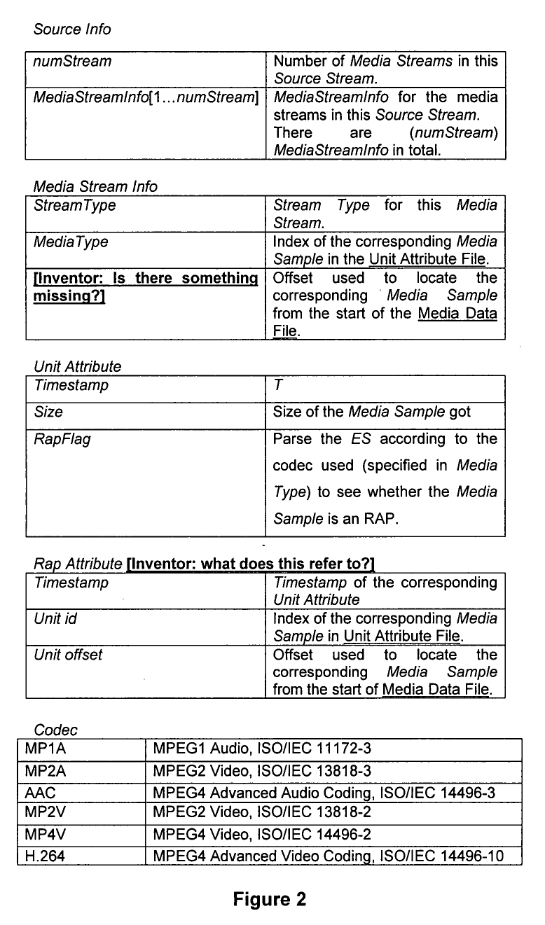

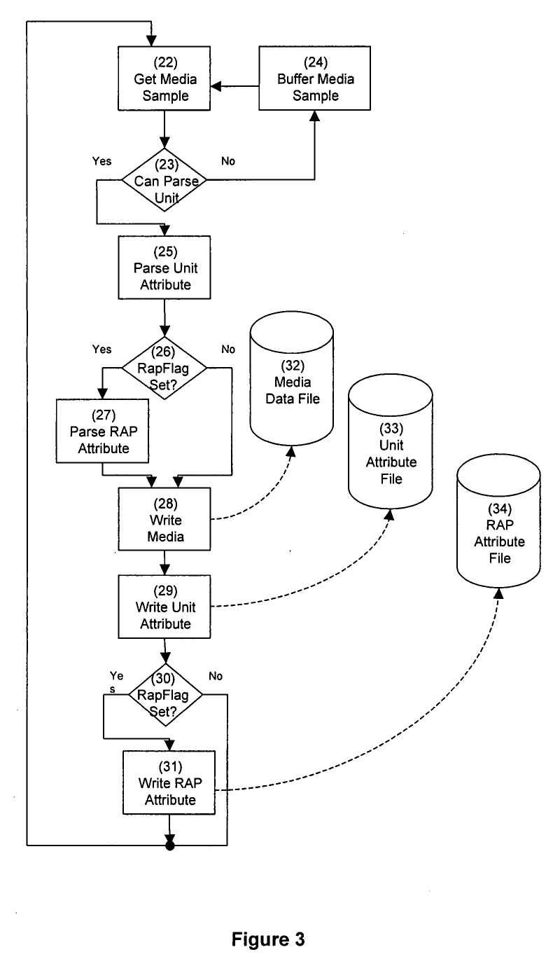

USRE can give a serial number SI to the S upon startup, and the S can be stored in a Source Info File. As would be appreciated by a person skilled in the art, a startup data stream could be assigned any serial number of desire, in which the number “1” would be preferred due to ease of programming. The logical structure of the Source Info file of an embodiment of this invention is shown in FIG. 2. After the USRE (11) has been started, the USRE (11) can then handle each Media Stream Info file in SI of S according to the flow as shown in FIG. 3. The logical structure of the Media Stream Info file of an embodiment of this invention is shown in FIG. 2. Indices are given to the Media Stream Info file from the Media Source Info file.

According to FIG. 3, a Media Sample is obtained from the Media Stream from S (22). Unit Attributes of this Media Sample will be parsed into a Unit Attribute File. Depending on the Stream Type, a Media Sample may not be able to provide enough info to parse a Unit Attribute. Then the USRE will buffer Media Samples until a Unit Attribute can be parsed. The instance when a Media Sample provides enough info for parsing a Unit Attribute would be determined by the Stream Type and the corresponding specifications.

For a particular Stream Type ES, a corresponding Timestamp t would be obtained from the clock of the AV encoder, as would be understood by a person skilled in the art.

For Stream Type TS, the TS packets can be buffered until a complete Packetized Elementary Stream (PES) defined in ISO 13818-1 can be found. The attributes of this PES is then parsed according to ISO/IEC 13818-1:2000 2.4.3.7 and create an Unit Attribute, which can later be stored in the Unit Attribute file. After the parsing of the Unit Attribute, all of the TS packets buffered will be passed to the Rap Flag (24) (single TS packet at a time) with this Unit Attribute. The step of RapFlag set (24) refers to the determination of whether Rapflag in the Unit Attribute is set, for example, to a non-zero value. A PES may comprise several TS packets. This set of TS packets are passed to step (26) together with the Unit Attribute. Rapflag in the Unit Attribute is set to correspond with the random-access-indicator bit in the PES header. One should note that only complete TS packets, preferably one TS packet at a time, are passed to the step (26).

If the Rap Flag for this Media Sample is set, it would be necessary to extract the Rap Attribute (24) according to FIG. 2.

After the Rap Flag is handled, the Media Sample is written to Media Data File, and then the Unit Attributes are written to the Unit Attribute File (26 & 27) in binary format as would generally understood by a person skilled in the art.

If the particular Media Sample has a positive RapFlag, the Rap Attribute is written to RAP Attribute File in binary format as would generally understood by a person skilled in the art.

### Use of the Media Data File, Unit Attribute File, and Rap Attribute File in the Playback of the Media

### Normal Playback

A player software could read the Source Info from Source Info File first. Then, for each Media Stream in the Source Info that is selected to be played by the player software, the Unit Attribute in Unit Attribute File would be read sequentially to obtain the Size (for example, in bytes) of data from the Media Data File. The RAP Attribute could be obtained from the RAP Attribute File if the RapFlag in the Unit Attribute for this Media Sample is set to be positive.

For each read operation from Source Info File, Unit Attribute File, Media Data File or RAP Attribute File, the offset the read pointer is incremented by the amount read so that the next read operation can read new data.

Therefore, the player would be able to obtain an exact replica of the Source Stream provided to USRE.

### Seek Operation

Most codec utilize temporal redundancy to archive compression. This may cause some samples dependent on other samples. The independent samples are so-called Random access point. After a seek operation, an RAP Media Sample near the seek time has to be decoded, otherwise the decoder will output corrupted data.

In this case, the player software first looks for the RAP Attribute from the RAP Attribute File with the largest Timestamp less than the time the user wanted to seek to. The Unit id of the RAP Attribute is then used to calculate the offset of the Unit Attribute of the corresponding Media Sample in the Unit Attribute File. The corresponding Unit Attribute's offset equals to the Unit id*Size of Unit Attribute. With the Unit Attribute and offset in the Media Data File of the Media Sample with RapFlag, the player can then obtain the RAP Media Sample and start playback.

As an example, the operation of a particular URSE of this invention is described below:

(10) The Input Selector (IS) triggers the start of the USRE for under two conditions:
S has been changed e.g. change of S from DVB, S3 to AV, or so on;
S has been stopped.

Upon startup of the whole process, USRE (11) could be given the SI of S, which will be stored in the Source Info File. After the USRE (11) has been started, each Media Stream in SI of S will be handled according to the processes shown in FIG. 3 as follows:
(22) Obtain a Media Sample in the Media Stream from S.
(23) Test, according to the Stream Type, whether a Unit Attribute can be parsed from this Media Sample (together with the buffered Media Samples).
(24) Store the Media Samples in the order they are received.
(25) Parse the Unit Attribute for the particular Media Sample as follows:
   i) For Stream Type ES, a corresponding Timestamp t will be obtained from the AV encoder and the Unit Attribute can be constructed as follows:

Unit Attribute

| | |
|---|---|
| Timestamp | t |
| Size | Size of the Media Sample |
| | obtained |
| RapFlag | Parse the ES according to the |
| | codec used (specified in Media |
| | Type) to see whether the Media |
| | Sample is an RAP. |

ii) For Stream Type TS, the TS packets are buffered (through the sequences (22), (23), (24)) until a complete PES can be found. The attributes of this PES is then parsed according to the standard described in ISO/IEC 13818-1:2000 2.4.3.7, and a Unit Attribute is created. After the parsing of the Unit Attribute, all TS packets buffered at the step (23) will be passed to the step (26) (one TS packet at a time) with the respective Unit Attribute as follows:

Unit Attribute

| | |
|---|---|
| Timestamp | t |
| Size | Size of the Media Sample got |
| RapFlag | Parse the ES according to the |
| | codec used (specified in Media |
| | Type) to see whether the Media |
| | Sample is an RAP. |

(26) Determine whether the RapFlag in the Unit Attribute is set to be a non-zero value.
(27) If the RapFlag of the particular Media Sample is set to be a non-zero value, the Rap Attribute of this sample will be extracted as follows:

Rap Attribute

| | |
|---|---|
| Timestamp | Timestamp of the corresponding |
| | Unit Attribute |
| Unit id | Index of the corresponding Unit |
| | Attribute in Unit Attribute File. |
| Unit offset | Offset used to locate the |
| | corresponding Media Sample |
| | from the start of Media Data File. |

(28) The Media Sample is written to the Media Data File.
(29) The Unit Attribute is written to the Unit Attribute File.
(30) Determine whether the RapFlag in the Unit Attribute is set to be a non-zero value.
(31) If the RapFlag of the particular Media Sample is set to be a non-zero value, the Rap Attribute is written to the RAP Attribute File.
(32) Media Data File for storing the Media Sample in the order they are received.
(33) Unit Attribute File for storing Unit Attribute of the Media Samples in the order they are parsed.
(34) RAP Attribute File for storing Rap Attribute of the RAP Media Samples in the order they are parsed.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A method of storing media data delivered to a client, said media data being encoded in at least one format, said method including the steps of:
identifying the format of the media data whenever the media data is received by the client;
analyzing the media data to extract unit attributes from the media data, wherein said unit attributes includes timestamp, size, media type, stream type, and random access point flag; and wherein said unit attributes are stored in a media attribute file;
storing the media data to a media storage file according to the sequence of the media data sent to the client.

2. The method of claim 1 further including the step of:
analyzing the media data to extract random access attributes from the media data, said random attributes
including timestamp, unit identifier, and unit offset; and
being stored in a random access attribute file.

3. The method claim 1 further including the step of:
repeating the steps of claim 1 whenever the format of the media data is changed.

4. The method of claim 1, wherein the media data is video data.

5. The method of claim 1, wherein the media data is audio data.

6. The method of claim 1, wherein the media data delivered to the client via internet.

7. A system of storing media data delivered to a client, said media data being encoded in at least one format, said system including:
a processor for identifying the format of the media data whenever the media data is received by the client;
a first analyzer for analyzing the media data to extract unit attributes from the media data, wherein said unit attributes includes timestamp, size, media type, stream type, and random access point flag; and wherein said unit attributes are stored in a media attribute file;
storage medium for storing the media data to a media storage file according to the sequence of the media data sent to the client.

8. The system of claim 7 further including a second analyzer for analyzing the media data to extract random access attributes from the media data, said random attributes
including timestamp, unit identifier, and unit offset; and
being stored in a random access attribute file.

9. The system of claim 7, wherein the media data is video data.

10. The system of claim 7, wherein the media data is audio data.

11. The system of claim 7, wherein the media data delivered to the client via internet.
